(19) United States
(12) Patent Application Publication
(10) Pub. No.: US 2009/0266857 A1
(43) Pub. Date: Oct. 29, 2009

(54) REAL ESTATE SIGN CARRIER

(76) Inventor: Gerry Dennis, Liberty Township, OH (US)

Correspondence Address: WOOD, HERRON & EVANS, LLP, 2700 CAREW TOWER, 441 VINE STREET, CINCINNATI, OH, 45202, US

(21) Appl. No.: 12/111,250

(22) Filed: Apr. 29, 2008

(51) Int. Cl. B60R 11/00

(52) U.S. Cl. 224/489

(57) ABSTRACT

A carrier for real estate signs is mounted on the back of a motor vehicle to allow signs to be carried outside the vehicle rather than inside the vehicle. This keeps the dirty or wet signs from soiling the vehicle. The carrier may be mounted to a trailer hitch. The carrier has two ends to capture the two ends of the sign. The ends are adjustable relative to one another, preferably by sliding them apart or together. One end, such as a retaining end, has holes to allow the sign legs to pass through, and thereby retain the signs from sliding off the other end, such as the channel or tray end.

### FIELD OF THE INVENTION

The present invention relates to carriers for carrying real estate signs on the exterior of a vehicle.

### BACKGROUND OF THE INVENTION

Real estate agents advertise houses for sale, and announce open-house events by placing metal signs in lawns at various locations in a neighborhood. These signs may need to be frequently moved as open-house events approach and are completed. These signs often have dirt on at least the portions that penetrate into the soil. In addition, if it has rained or snowed, the entire sign may be wet.

Until now, agents have carried the signs inside their motor vehicle. This exposes the passenger compartment or the trunk of the motor vehicle to moisture and dirt. A desired improvement is to have a system such as a carrier to carry signs outside the vehicle. Real estate agents should be able to easily load and unload the signs. They should be able to easily mount and dismount the carrier from the motor vehicle, since such a carrier is not always needed.

### SUMMARY OF THE INVENTION

To achieve the foregoing objectives, and in accordance with the purposes of the invention as embodied and broadly described, a carrier for mounting on the rear of a motor vehicle is adapted to carry at least one real estate sign, so that the dirt on the sign is kept out of the vehicle. The carrier has a mounting interface to mount to the vehicle. In one embodiment the interface attaches to a trailer hitch of the type typically made of square or rectangular tubing.

The carrier has a channel that carries the weight of the signs. To keep the signs from sliding out of the channel there are holes in the carrier that hold the legs of the sign, thereby retaining the sign from significant lateral movement. These holes may be in the channel, or they may be in a retainer spaced away from the channel. The retainer also prevents the signs from tumbling out of the channel.

To load and unload the carrier the retainer's position relative to the channel is altered, such as by moving it closer or further away. In one embodiment, the retainer slides along a rail between the retainer and the channel and does not need to be removed from the rail. Preferably, the rail is vertical, the channel is at the bottom, and the retainer, with the apertures, is near the top. In this embodiment the signs are loaded with their legs pointing upwards.

### BRIEF DESCRIPTION OF THE DRAWINGS

These and other features, aspects, and advantages of the present invention will become better understood with regard to the following description, appended claims and accompanying drawings wherein:

FIG. 1 is perspective view of a motor vehicle carrying an embodiment of the invention, with a sign shown in phantom lines with the sign panels removed for clarity.

FIG. 2A is a cross-section as indicated in FIG. 1.

### DETAILED DESCRIPTION

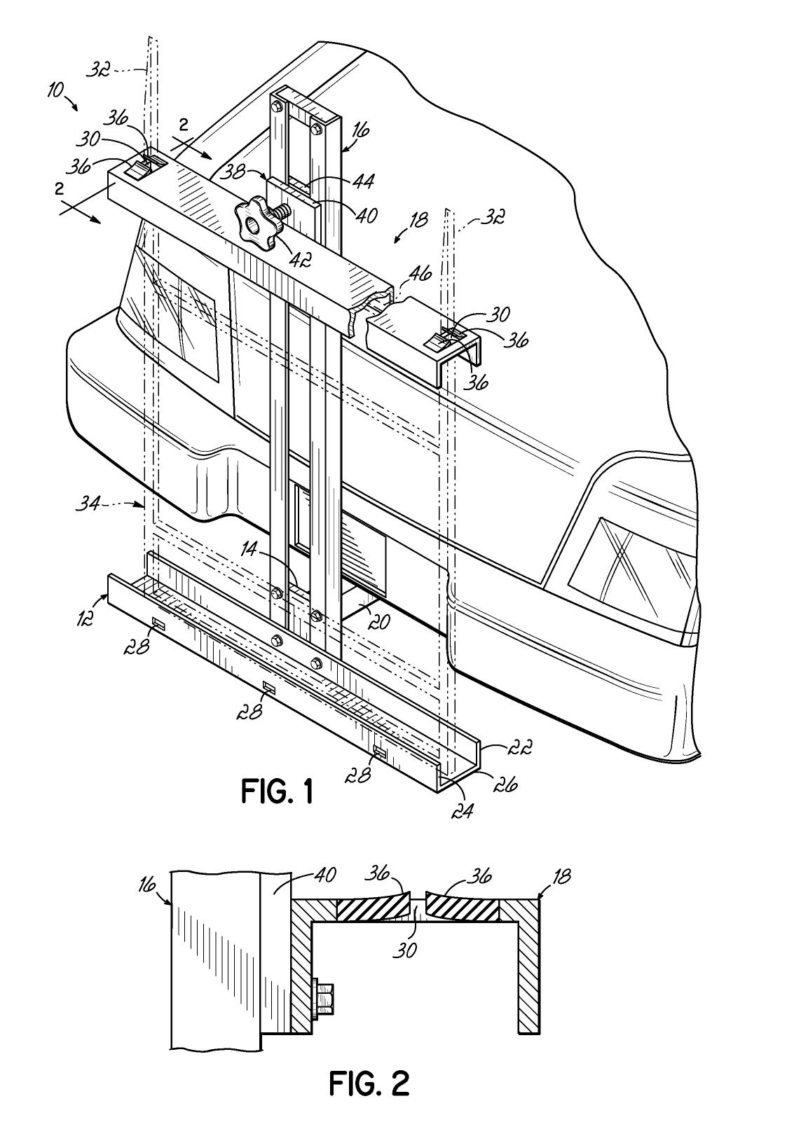

The embodiment illustrated in FIG. 1 is sized for a particular style and size (width) of sign. The sign is shown in phantom lines, and its sheet metal panel is removed so the invention can be better viewed. In addition to the major sheet metal panel, signs often have “rider” panels that are smaller and positioned above or below the main panel. These rider panels will often have phrases such as “price reduced” or “warranty available”. These rider panels are also removed so the invention can be better viewed. In using the current invention there is no reason for any of the panels to be removed.

The embodiment shown is mounted to a trailer hitch of a motor vehicle. It is envisioned that this would be the most common way to mount the carrier to a vehicle. However, the description of this embodiment does not preclude embodiments that use different means for mounting, for example straps having rubber coated clips and supports, such as those used with certain styles of bicycle carriers.

Further, the embodiment described requires the legs of the sign to point upwards. This is the currently preferred embodiment, because by pointing the legs upwards, the entire carrier may be positioned lower on the vehicle. If the legs were pointed downwards to pass through holes in the bottom of the carrier, the legs would pose a ground-clearance issue. The issue would most likely require the carrier to be positioned higher on the vehicle, possibly blocking visibility. It would also require the real estate agent to lift the sign higher off the ground.

As will be described in subsequent paragraphs, the embodiment illustrated has leg-accepting holes fixed at a particular spacing. A perusal of websites that sell signs reveals examples of signs that have panel widths, and therefore leg spacings, of approximately 18, 24, 28, 30, and 36 inches. A different style of sign has legs that converge below the panel. The spacing of these converging legs is not specified, but visually they are clearly less than 18 inches apart. Therefore, it is envisioned that the spacing of the holes should accommodate a wide variety of leg spacings. Among ways to accomplish this are; by including a plurality of holes, using elongated openings, or by employing multiple carrier components having holes of different spacings.

Referring now to FIGS. 1 and 2, the sign carrier 10 has a lower channel 12, a mount 14, a vertical member 16 and a retainer 18. The mount is well known in the art, and for example would be a square or rectangular bar 20 that mounts into the square or rectangular tube of a trailer hitch mounted to the motor vehicle. Or, it may be any other system that retains the sign carrier 10 to the motor vehicle in a stable manner. The illustration shows several fasteners attaching pieces together, however the construction method of the carrier is not significant. The pieces may be fastened using fasteners, by welding, or by any suitable technique. Since moisture and road salt are often at the back of a motor vehicle, precautions to prevent corrosion should be incorporated in the choice of materials and the component designs. Welded aluminum is envisioned as a lightweight corrosion resistant construction method.

The lower channel 12 has a forward vertical rail 22, an aft vertical rail 24, and a bottom 26. Sides are not necessary, but may be included. However, sides may limit the size of sign that can be transported. The aft vertical rail 24 is shown at approximately the same height as the forward vertical rail 22, but it may be beneficial to make the aft vertical rail 24 substantially higher, or to provide it with extensions (not shown). The reason for this will be described later. The lower channel 12 carries the weight of the signs, and is therefore mounted close to the mount 14, to minimize the torque that the mount must handle. Optional drain holes 28 are representative of the need to allow rainwater to drain so that a real estate agent will encounter less water dripping from the sign as they lift it from the carrier.

The retainer 18 may be of any sturdy size and shape, for example, a channel as illustrated. Two holes 30 are sized and spaced to receive the legs 32 of one or more signs 34. As described earlier, there may be multiple holes or another arrangement to receive the legs 32. It is important that the signs 34 are retained from excessive side-to-side movement as the vehicle drives around corners. Optional rubber flaps 36 are installed at the holes as an example of one method to deaden the rattling noises caused by signs moving in the holes 30.

The retainer 18 is adjustably mounted on the vertical member 16. The mounting may be by way of discreet holes (not shown) in the vertical member 16 cooperating with fasteners. Or, preferably, the retainer 18 is slidably mounted by an adjuster assembly 38 on the vertical member as in the illustrated embodiment. As used in this application, slidably mounted and slidably adjusted are defined as moving one piece relative to another without requiring removal and repositioning. Adjuster assembly 38 is not new in the art, and may be designed in a variety of configurations. For example, in the embodiment illustrated, an aft plate 40 is fastened to the retainer 18 and has a threaded member 42 passing through it into a captured nut (not shown) on a forward plate 44. The threaded member 42 has a surface (not shown) that can push against the aft plate 40. As the threaded member 42 is turned clockwise in the captured nut, the aft plate 40 is pushed closer to the forward plate 44 until the vertical member 16 is squeezed between them. This keeps the retainer 18 in a chosen position along the vertical member 16.

In any design of the adjuster assembly 38, it is preferable that all pieces are captured to the vertical member 16 so that none of them, including the retainer 18, can fall off the vertical member 16 even if the adjuster assembly 38 is not properly tightened.

In use, to load the carrier 10 a real estate agent moves the retainer 18 to a chosen raised position along the vertical member 16 and tightens it in position. Then the signs 34 are loaded upside down in the lower channel 12 so that the legs 32 approximately align with the holes 30. When all signs 34 are in position, the retainer 18 is lowered as low as it will go. This may be at a mechanical stop (not shown) on the vertical member 16, or it may be when the retainer contacts a lower rail 46 of the sign 34. If there are signs of different construction, the retainer 18 will stop when it hits the highest lower rail 46 of the group. The threaded member 42 is then tightened to keep the retainer 18 in position during vehicle movement. The signs 34 are retained in the lower channel 12 and the holes 30. Although it is also possible to drive the motor vehicle without tightening the threaded member 42 and thereby retainer 18, tightening will minimize rubbing and wear. Removal of the signs 34 is done in the reverse order of installation. If the vehicle is driven with an empty carrier 10, the retainer 18 should be lowered, and threaded member 42 tightened.

As previously discussed, the aft vertical rail 24 may need to be higher than the forward vertical rail 22. This is because the height of the aft vertical rail 24 is a trade-off of at least two factors. First, if the sign is going to fall or be ejected from the carrier, it should be realized that this would likely be in the aft direction, over the aft vertical rail 24. It will not happen in the forward direction because the vertical member 16 is adjacent the signs. Ejection is most likely to happen when going over a bump, propelling the signs 34 upward, temporarily carrying the retainer 18 upward with them. If the lowest edge of the aft most sign is propelled higher than the aft vertical rail 24, and if during this time the car accelerates, the signs may not return to the confines of the lower channel 12. For this reason, a high aft vertical rail 24 is desired. However, the higher the aft vertical rail 24, the higher the real estate agent must lift the sign during loading and unloading. Fortuitously, this is alleviated by the ability to slide signs into the lower channel 12 through the open sides. Similarly, if the sides of the lower channel 12 are not open, keeping them low will ease sign installation.

While the foregoing description has set forth preferred embodiments of the present invention in particular detail, it must be understood that numerous modifications, substitutions and changes can be undertaken without departing from the true spirit and scope of the present invention as defined by the ensuing claims. The invention is therefore not limited to specific embodiments as described but is only limited as defined by the following claims.

What is claimed is:

1. A real estate sign carrier for mounting on the rear of a motor vehicle to carry at least one real estate sign that has a ground penetrating leg comprising:
a mounting interface;
a channel to carry the real estate sign;
a retainer spaced from the channel;
wherein the channel is adapted to hold one end of the sign and the retainer is adapted to retain a second end of the sign so the sign remains in the carrier until the retainer is moved to release the sign.

2. A real estate sign carrier as in claim 1 further comprising:
at least one aperture that surrounds at least one ground penetrating leg of the sign.

3. A real estate sign carrier as in claim 2 wherein the at least one aperture is in the retainer.

4. A real estate sign carrier as in claim 1 further comprising:
a vertical member on which the retainer is moved to adjust the spacing from the channel.

5. A real estate sign carrier as in claim 4 further comprising:
an adjuster that attaches the retainer to the vertical member so that the retainer may be spaced from the channel an amount chosen by a person loading the carrier.

6. A real estate sign carrier as in claim 5 wherein the adjuster slidably attaches the retainer.

7. A real estate sign carrier as in claim 1 further comprising:
an adjuster that slidably adjusts a distance that defines how the retainer is spaced from the channel.

8. A real estate sign carrier as in claim 1 wherein the ground penetrating legs point upwards when the sign is carried in the real estate sign carrier.

9. A real estate sign carrier as in claim 1 wherein the mounting interface is a trailer hitch interface.

10. A carrier for carrying soil penetrating real estate signs on the rear of a motor vehicle comprising:
a lower portion carrying the weight of the signs;
an upper portion to prevent the signs from tipping off the lower portion;
at least one aperture enclosing at least one leg of the signs to keep the signs from sliding off the lower portion while the vehicle moves.

11. A carrier as in claim 10 wherein the lower portion further comprises an upward extending rear edge and open left and right sides.
